(19) United States
(12) Patent Application Publication
(10) Pub. No.: US 2008/0005683 A1
(43) Pub. Date: Jan. 3, 2008

(54) AUTHORING SYSTEM, SOFTWARE, AND METHOD FOR CREATING CONTENTS

(75) Inventor: Mihoko Aoki, Kawasaki-shi (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/764,264

(22) Filed: Jun. 18, 2007

(30) Foreign Application Priority Data
Jun. 30, 2006 (JP) 2006-182665

(51) Int. Cl. G06F 3/048

(52) U.S. Cl. 715/763

(57) ABSTRACT

In an authoring system, contents to be created include elements having a tree structure and attribute values for specifying the appearance elements. The authoring system is provided with a storage unit for storing the contents; a first display unit for displaying a first graphical user interface for specifying attribute values; a search unit for searching the tree structure contained in the contents to determine whether determination by a first attribute value and by a second attribute value may overlap each other for the appearance of a first element to be edited, using the first graphical user interface; and a second display unit for displaying information related to an overlapping on the first graphical user interface, on condition that a determination unit has determined that there is overlapping.

### FIELD OF THE INVENTION

The present invention generally relates to a graphical user interface. More specifically, the present invention relates to an authoring system, software, and a method for creating contents having one or more elements and a tree structure of the elements.

### BACKGROUND

With the spread of the Internet in recent years, on a daily basis a company or an individual may create and release multimedia web contents on the Internet. The web contents are usually created as a structured document in accordance with a format of HTML language or XML language.

In the HTML language for creating the web contents, elements to be displayed are hierarchically described using a tree structure. A creator of the web contents can specify the appearance (a background color, a font, a character color, width, height, or the like) of a certain element of the web contents by a plurality of methods. For example, it is possible to determine the appearance of the element by directly specifying an attribute for the specific element. By using a style sheet in the element in a specific hierarchy having a tree structure and causing other hierarchies to inherit contents of the style sheet, it is also possible to determine the appearance of the elements in the other hierarchies. See, for example, “HTML 4.01 Specification W3C Recommendation”, [online], issued on Dec. 24, 1999, The World Wide Web Consortium (W3C), [searched on Jun. 30, 2006], Internet: <http://www.w3.org/TR/REC-html40> or “Cascading Style Sheets, Level 2 revision 1 CSS2.1 Specification”, [online], issued on Apr. 11, 2006, The World Wide Web Consortium (W3C), [searched on Jun. 30, 2006], Internet: <http://www.w3.org/TR/CSS21/>.

For supporting creation of the web contents, authoring software, referred to as a WYSIWYG (What You See Is What You Get) editor, is provided, which can directly output what is seen on a display screen at the time of creation and edit as the web contents, such as an HTML document. For example, the present applicant, International Business Machines Corporation provides an IBM Rational Application Developer (RAD) product as the WYSIWYG editor.

FIG. 6 illustrates an example of a window 600 as an interactive graphical user interface provided by the RAD product. The window 600 includes a contents viewer 620 for displaying contents to be edited, a style edit view 625 for editing a style, and an attribute edit view 630 for editing attribute specification. By providing such an interactive interface, the RAD product supports development of efficient web contents. See “Rational Application Developer for WebSphere Software V6.0, Basic Operation”, p. 19-24, [online], issued on Oct. 19, 2005, International Business Machines Corporation, [searched on Jun. 30, 2006], Internet <http://www-Internet06.ibm.com/jp/software/websphere/developer/rad/v6/BASIC/>.

Many companies in the industry have also been developing a content managing program or the authoring software. For example, Japanese Unexamined Patent Publication (Kokai) No. 2004-38283 discloses the content managing program for updating a web page file before edit by having edited the contents downloaded from a web server into a terminal by an editing unit incorporated as plug-in in a browser of the terminal and then uploading the contents.

### SUMMARY

Generally, when the appearance of a certain element of web contents is specified by both of an attribute specification and a style thereof, the specification by the style is given priority as for the appearance of the element. Accordingly, when a creator of the contents tries to change the appearance of the element whose appearance has already been specified by the style by editing the attribute specification, the creator notices that it is not possible to change the appearance with the attribute specification. A user will then search the style applied to the element for editing. The problem reducing convenience for the user cannot be solved by any of the background art.

Therefore, it is one of the objectives of the present invention to provide an authoring system, software, and a method for efficiently supporting edit or creation of the contents.

In order to achieve the above-mentioned objective, there is provided an authoring system for creating contents. The contents include: one or more elements; a tree structure of the elements; a first attribute value for determining appearance of a first element by performing specification for the first element as an object for determining the appearance thereof, and a second attribute value for determining the appearance of the first element by applying specification for either whole contents or the one or more elements to the first element. The authoring system is provided with: a storage unit for storing the contents; a first display unit for displaying a first graphical user interface for performing specification for the first attribute value; a search unit for searching the tree structure contained in the contents to determine whether or not determination by the first attribute value and determination by the second attribute value may overlap each other with regard to the appearance of the first element to be edited, using the first graphical user interface; and a second display unit for displaying information related to the overlapping on the first graphical user interface, on condition that a determination unit has determined that there is overlapping.

Preferably, the first display unit displays a second graphical user interface for achieving specification for the second attribute value and a viewer for displaying the contents to be edited.

Preferably, on condition that the search unit has determined that there is overlapping, the second display unit displays a message that there is overlapping and/or information specifying the second attribute value taking precedence over the appearance by the first attribute value, and provides an interface for editing the second attribute value overlapping with the first attribute value, on the first graphical user interface.

Although the present invention has been schematically described as the authoring system for creating contents, it is also possible to understand the present invention as authoring software, a software product, and a method. The software product can include a storage medium storing the above-mentioned software or a medium for transmitting the software.

### BRIEF DESCRIPTION OF THE DRAWINGS

FIG. 1 illustrates an example of appearance of a data processing system in an embodiment of the present invention;

FIG. 2 illustrates an example of a hardware configuration of an information processor suitable for achieving the data processing system in the embodiment of the present invention;

FIG. 3 is a functional block diagram of a contents authoring system in the embodiment of the present invention;

FIG. 4 is a flow chart representing an operation of the contents authoring system in the embodiment of the present invention;

FIG. 5 is a flow chart representing search processing of a tree structure of contents in the embodiment of the present invention;

FIG. 6 illustrates an example of a graphical user interface of an authoring system of the embodiment of the present invention;

FIG. 7 illustrates a scene of an attribute edit view of the authoring system in the embodiment of the present invention; FIG. 8 illustrates a scene of the attribute edit view of the authoring system in the embodiment of the present invention;

FIG. 9 illustrates an example of HTML description of the contents to be edited in the embodiment of the present invention;

FIG. 10 illustrates an example of a hierarchical structure of the contents to be edited in the embodiment of the present invention; and

FIG. 11 illustrates an example of an attribute correspondence table in the embodiment of the present invention.

### DETAILED DESCRIPTION

Hereinafter, the best mode for carrying out the present invention will be described in detail based on the drawings. However, embodiments below do not limit the invention according to the claims, and all of the combinations of features described in the embodiments are not necessarily essential to means for solving the invention.

In addition, the present invention can be carried out in many different modes and should not be construed as limited to contents of description in the embodiments. It should also be noted that all of the combinations of the features described in the embodiments are not necessarily essential to means for solving the invention. The same numerals are given to the same elements throughout the description in the embodiments.

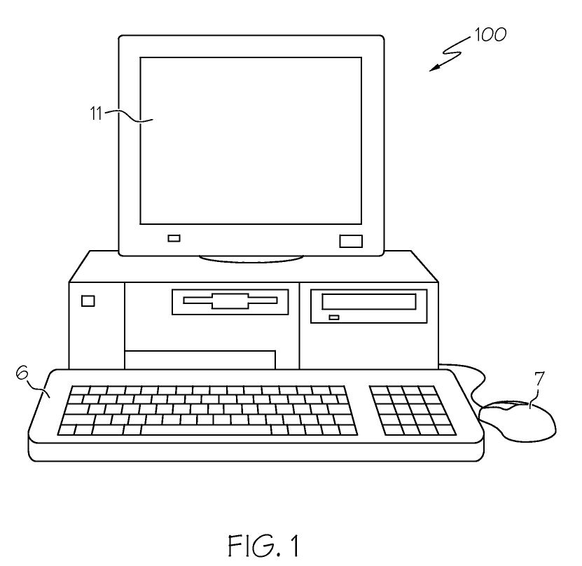

FIG. 1 illustrates an example of appearance of an authoring system 100 according to an embodiment of the present invention. The authoring system according to the embodiment of the present invention includes a keyboard 6, a mouse 7, and a display 11.

The display 11 in the authoring system 100 according to the embodiment of the present invention visually presents information on a work condition or the like for a user. The user can use an input device, such as the keyboard 6 and the mouse 7, to operate a plurality of windows displayed on the display 11 by a multiwindow operating system and utilize a desired one among one or more computer software applications. The user operates the displayed window (for example, expansion/reduction operation of the window) in order to efficiently use the application.

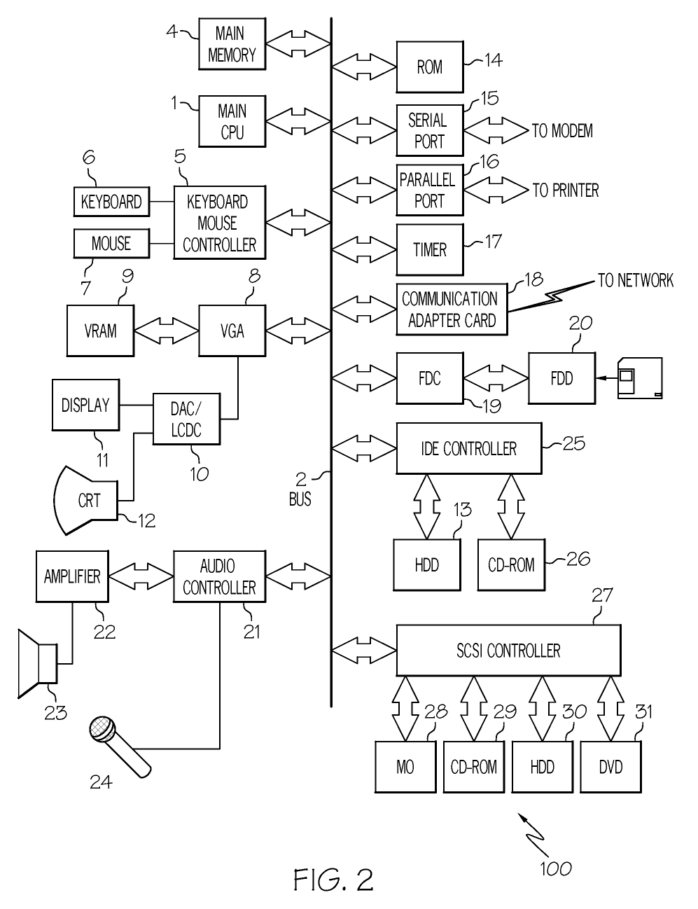

FIG. 2 illustrates an example of a hardware configuration of an information processor suitable for achieving the authoring system 100 in the embodiment of the present invention. The information processor includes a CPU (central processing unit) 1 and a main memory 4 connected to a bus 2. Hard disk drive units 13 and 30 as well as a removable storage (an external storage system capable of exchanging a recording medium), such as CD-ROM devices 26 and 29, a flexible disk device 20, an MO device 28, and a DVD device 31, are connected to the bus 2 via a floppy (R) disk controller 19, an IDE controller 25, a SCSI controller 27, or the like.

The recording medium, such as a flexible disk, an MO, a CD-ROM, and a DVD-ROM, is inserted in the removable storage. Such a recording medium, the hard disk drive units 13 and 30, or a ROM 14 can record codes of a computer program for providing instructions to the CPU or the like in cooperation with an operating system and carrying out the present invention. The computer program is executed by being loaded into the main memory 4. It is possible to compress the computer program or divide the same into plurality of pieces to record the same on a plurality of media.

The information processor receives an input from the input device, such as the keyboard 6 or the mouse 7, via a keyboard/mouse controller 5. The information processor is connected to the display 11 for presenting visual data to the user via a DAC/LCDC 10.

The information processor can be connected to a network via a network adaptor 18 (an Ethernet (R) card or a token ring card) or the like to communicate with other computers or the like. Although not illustrated, it is also possible to connect the information processor to a printer via a parallel port or to a modem via a serial port.

From the above description, it can be readily understood that the information processor suitable for achieving the authoring system according to the embodiment of the present invention is achieved by the information processor, such as a usual personal computer, a workstation, and a mainframe, or a combination thereof However, these elements are illustrative and all the elements are not necessarily essential for the present invention.

It is a matter of course that a person skilled in the art can readily conceive various modifications such as combining a plurality of machines and distributing functions to the machines for implementing each of the hardware elements of the information processor to be used in the embodiment of the present invention. These modifications are concepts naturally included in the thought of the present invention.

The authoring system in the embodiment of the present invention adopts the operating system for supporting a GUI (graphic user interface) multiwindow environment, such as the Windows (R) operating system provided by Microsoft Corporation, the MacOS (R) provided by Apple Computer Incorporated, and the UNIX (R) system provided with the X Window System (for example, AIX (R) provided by International Business Machines Corporation).

From the description above, it can be understood that the authoring system used in the embodiment of the present invention is not limited to a certain multiwindow operating system environment.

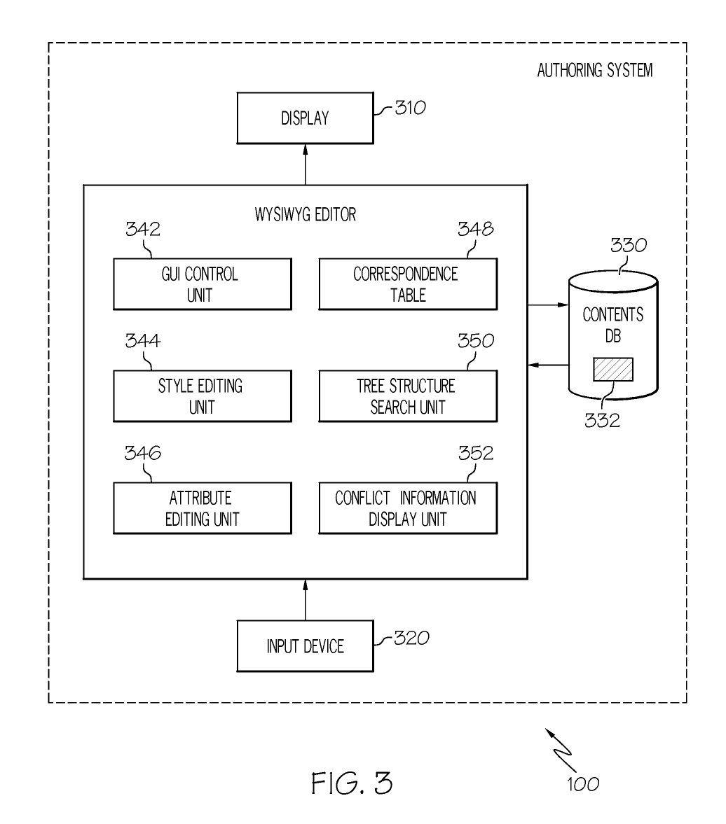

FIG. 3 is a functional block diagram in the authoring system 100 in the embodiment of the present invention. Incidentally, each element illustrated in the functional block diagram of FIG. 3 can be implemented in the information processor having the hardware configuration illustrated in FIG. 2, by having loaded the computer program such as the operating system or an authoring software stored in the hard disk drive unit 13 or the like onto the main memory 4, and then causing the CPU 1 to read the program in order to move a hardware resource and the software in concert.

The authoring system 100 is provided with a display 310, an input device 320, a contents database 330, and a WYSIWYG editor 340. The display 310 is provided with a function to display the graphical user interface and the like for creating the contents on a desktop screen in the operating system in accordance with the instruction of the WYSIWYG editor 340. The input device 320 is achieved by the keyboard 6, the mouse 7, or the like. The input device 320 receives the input of the operation or data for creating the contents from the user operating the data processing system 100.

The contents database 330 memorizes and stores the data of contents 332 edited and created by the WYSIWYG editor 340. In the embodiment of the present invention, the contents 332 are created in the format of HTML language.

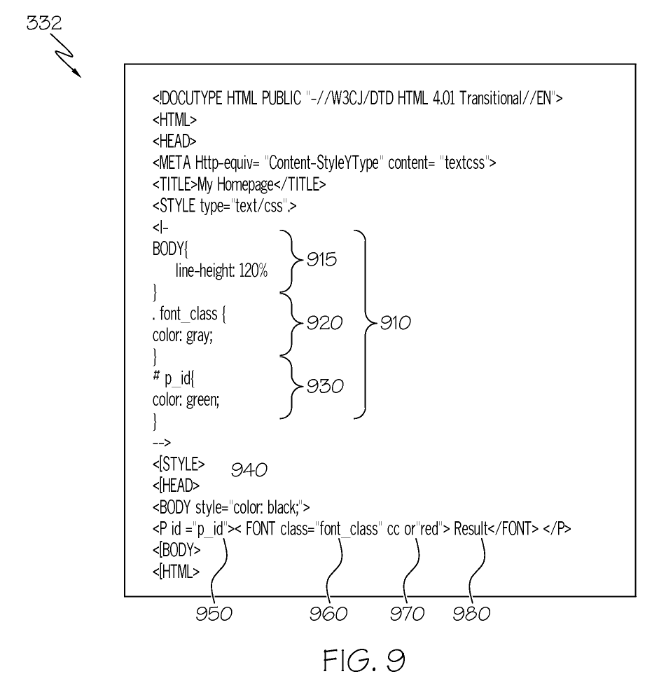

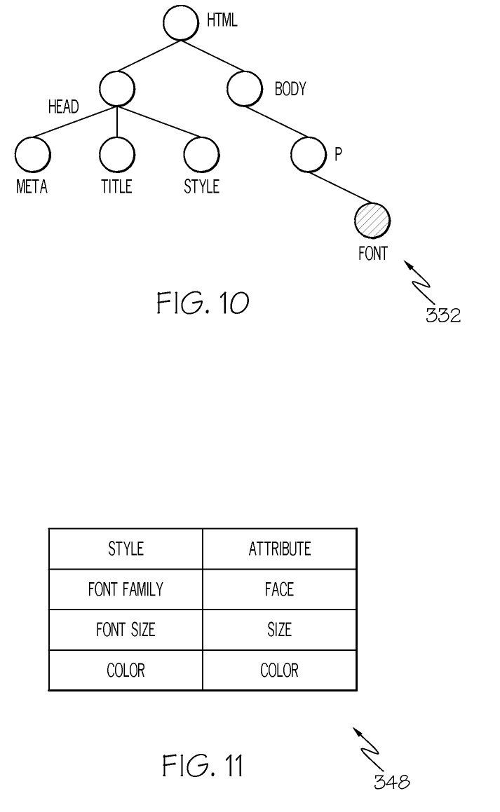

FIG. 9 illustrates an example of the contents 332 created in accordance with an HTML language specification in the embodiment of the present invention. In the embodiment of the present invention, the contents 332 contain elements having element names, “HTML”, “HEAD”, “TITLE”, “STYLE”, “BODY”, “P”, and “FONT”. It should be noted that these elements have a hierarchical structure illustrated in FIG. 10.

If the contents 332 illustrated in FIG. 9 are displayed with the browser (for example, Internet Explorer (R) of Microsoft Corporation) adapted to the HTML format, a character string “Result” (980) described in the “FONT” element is displayed. A color of the character which is a type of appearance of “Result” can be specified by attribute specification (970) or a style (915, 920, 930, and 940).

The attribute specification (970) determines the appearance of the element by direct specification within the description of the element for the element as an object for determining the appearance thereof (in the embodiment of the present invention, it means a “FONT” element). Meanwhile, the style (915, 920, 930, and 940) determines the appearance of the element as an object for determining the appearance thereof by applying the specification either in the whole contents or one or more elements contained in the contents.

When describing the style in more detail, there is a plurality of types of methods for determining the appearance of the element by specifying the style. Specifically, specification of the style can be achieved by description for specifying the style by an element name as a key (915), the style specification by a class attribute (920), the style specification by an ID attribute (930), and the style specification by a style attribute (940).

When further describing the style, the style specification by the element name (915), the style specification by the class attribute (920), and the style specification by the ID attribute (930) can be included in an external file, referred to as a CSS (Cascading Style Sheet) file, which is a file other than an HTML file describing a style element (910) having the element name “STYLE” or the element of the contents and the tree structure. When specifying the style in the CSS file, an address location (not illustrated because it is not used in the embodiment of the present invention) of the CSS file will be described in the HTML file, and the style in the CSS file is called up from the HTML file based on the address location to be used.

The style specification by the style attribute (940) can also be included in the element other than the element as an object for determining the appearance thereof or the element other than the style element (910). In the embodiment of the present invention, the style specification by the style attribute (940) is included in the description of the “BODY” element which is a further parent element of the “P” element which is a parent element of the “FONT” element as the element as an object for determining the appearance thereof.

The methods for specifying a plurality of styles and specifying the attributes have been described, however, it should be noted that there are priorities among the above in accordance with a CSS specification. Specifically, in the same element, the style specification by the style attribute (940) is given the highest priority to, and then the prioritizations are given to the style specification by the ID attribute (930), the style specification by the class attribute (920), and the style specification by the element name (915) in that order. The attribute specification (970) is given the lowest priority. Among the elements of different hierarchies, the style defined within the element having a hierarchical relationship close to the element as an object for determining the appearance thereof is dealt with the high priority.

In the example of FIG. 9, since there is provided a definition of (1) gray by the descriptions of 920 and 960 in the “FONT” element, (2) green by the descriptions of 930 and 950 in the “P” element, (3) black by the description of 940 in the “BODY” element, and (4) similarly “line-height=120%” by the description of 915 in the “BODY” element, the character color of “Result” is displayed in gray in accordance with the description of (1) with the highest priority.

There has been provided a description of an example of the contents 332 created in accordance with the HTML language specification and the CSS specification in the embodiment of the present invention with reference to FIGS. 9 and 10, however, since the HTML language specification and the CSS specification are well known to a person skilled in the art from the above-mentioned Non-patent Documents 1 and 2, the further detailed description thereof will be omitted.

Returning to FIG. 3, the WYSIWYG editor 340 in the embodiment of the present invention accesses the web contents 332 stored in the contents database 330 and provides a contents creator with a function to interactively edit the content thereof. Specifically, the WYSIWYG editor 340 is provided with a graphical interface control unit 342, a style editing unit 344, an attribute editing unit 346, an attribute correspondence table 348, a tree structure search unit 350, and a difference information display unit 352.

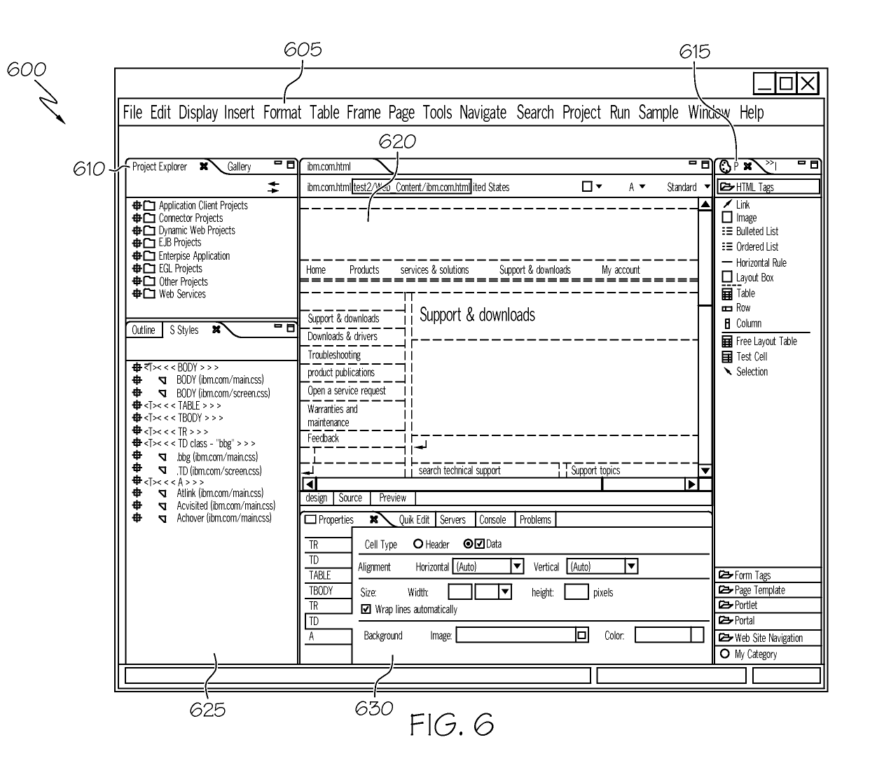

The graphical interface control unit 342 displays the graphical user interface, such as a window 600 of FIG. 6 which will be described later in detail, on the display 310 in the authoring system 100 to provide the contents creator with the interface for editing the contents 332. The style editing unit 344 and the attribute editing unit 346 provide a function to reflect the editing of the style and attribute specification performed by the contents creator through the style edit view 625 and the attribute edit view 630 included in the interface created by the graphical interface control unit 342 in the contents 332 stored in the contents database 330.

The attribute correspondence table 348 includes information related to a correspondence relationship between the style and the attribute specification to be used for determining whether or not the determination of the appearance by the attribute specification and the determination of the appearance by the style for a certain element may be different with each other. In the embodiment of the present invention, the attribute correspondence table 348 is created for each element contained in the contents 332. Incidentally, the attribute correspondence table 348 can be created in various formats, such as the XML format. FIG. 11 illustrates an example of the attribute correspondence table 348 created for the “FONT” element in the embodiment of the present invention. In an example of the attribute correspondence table 348, it is defined that each of attribute specifications, “face”, “size”, and “color” corresponds to each of styles, “font-family”, “font-size”, and “color”, respectively. It should be noted that such a table might be created for each element.

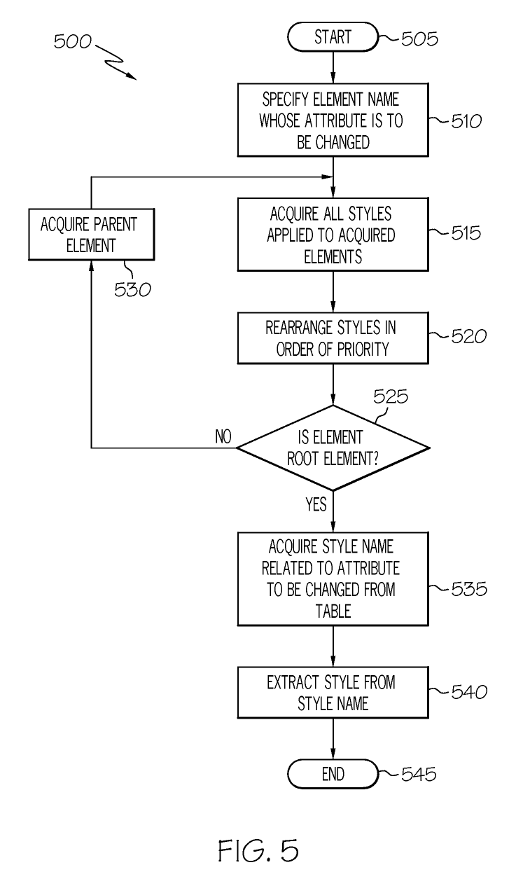

The tree structure search unit 350 provides a function to search the tree structure by performing process according to a flow chart 500 illustrated in FIG. 5 on the authoring system and perform information processing in accordance with the algorithm for determining whether or not the determination of the appearance by the attribute specification and the determination of the appearance by the style for a certain element may be different.

When it is determined as a result of the search by the tree structure search unit 350 that the determination of the appearance by the attribute specification and the determination of the appearance by the style for a certain element are different, the difference information display unit 352 provides a function to create a message that there is a difference and/or information related to the style taking precedence over the appearance by the attribute specification and transmit the same to the graphical user interface control unit 342 to display the same on the graphical user interface (specifically, the window 600) on the display 310. In addition, in such a case, the difference information display unit 352 also has a function to cause the graphical user interface control unit 342 to display an interface 810 for editing the style differing from the attribute specification.

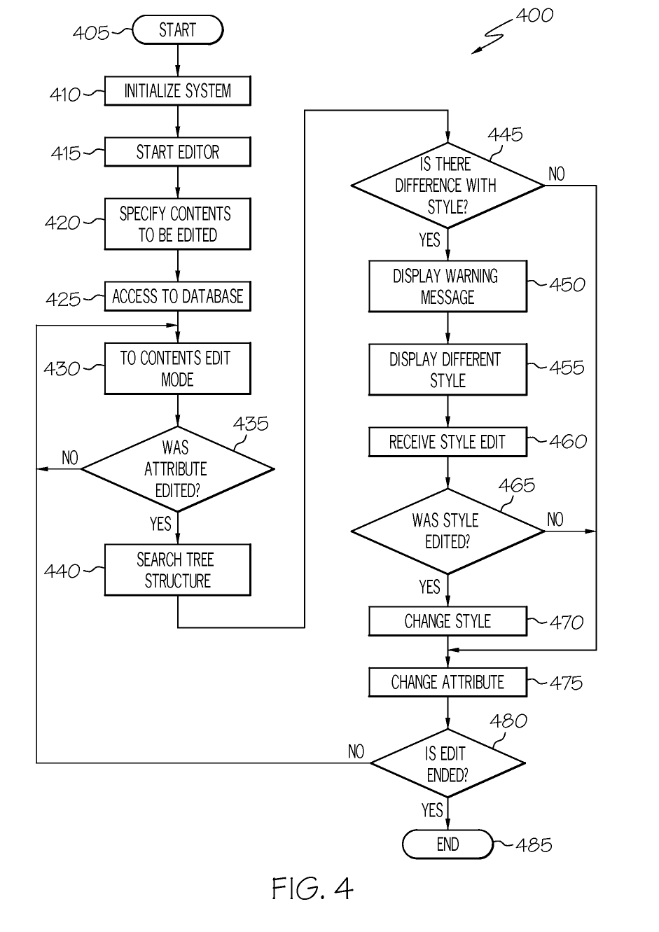

FIG. 4 is a flow chart 400 representing an operation of the authoring system 100 in the embodiment of the present invention. Process starts at Step 405 and the system is initialized at Step 410. Next, at Step 415, authoring software starts in response to an application starting action by the user (for example, by double-clicking on a starting icon representing the authoring software). In response to starting of the authoring software, the operating system creates the window corresponding to the WYSIWYG editor 340 supported by the started authoring software on a desktop screen in the multiwindow operating system displayed on the display.

The process proceeds to Step 420, and the contents creator uses a project explorer 610 which will be described later to specify the contents 332 to be edited. In response to the contents 332 subject to edit having been specified, the process proceeds to Step 425 and the WYSIWYG editor 340 accesses the database 330 to read the data of the contents 332.

The process further proceeds to Step 425, and the graphical user interface control unit 342 displays the data of the read contents 332 on the contents viewer 620 which will be described later and enters into a contents edit mode. In the contents edit mode, the contents creator can efficiently proceed with creation of the contents by operating the window displayed on FIG. 6. An example of the window corresponding to the WYSIWYG editor 340 after Step 430 is completed will be described with reference to FIG. 6.

FIG. 6 illustrates an example of the window corresponding to the WYSIWYG editor 340 in the embodiment of the present invention displayed on the display of the authoring system. The window 600 includes a menu bar 605, the project explorer 610, a pallet 615, the contents viewer 620, the style edit view 625, and the attribute edit view 630.

The menu bar 605 provides the contents creator with various functions, such as file manipulation and display control. The project explorer 610 is an interactive interface used for selecting the contents to be edited. The pallet 615 provides the element used as a part or a template of the contents. The contents creator can readily create the contents by dragging and dropping the part or the template of the pallet 615 onto an area of the contents viewer 620.

The contents viewer 620 displays the contents selected in the project explorer 610. The contents viewer 620 also has a function to update the display of the contents in the newest state in response to the contents having been edited. In order to present to the contents creator the similar appearance as the browser compliant with the HTML format, the contents viewer 620 displays the appearance by the style as a priority, when the determination by the attribute specification and the determination by the style are different regarding the appearance of the element of the contents. In addition, the contents creator can select the element to be edited in the style edit view 625, the attribute edit view 630, or the like by clicking an object displayed on the contents viewer 620 to select the same.

The style edit view 625 provides a function to edit the style applied to the contents selected by the project explorer 610. The attribute edit view 630 provides a function to edit the attribute specification of the element interactively selected in the contents viewer 620. The contents creator can create the contents, using window 600 as the interactive graphical user interface including these user interface elements 605 through 630.

Returning again to FIG. 4, the process proceeds to Step 435. At Step 435, it is determined whether or not the attribute specification of the element interactively selected in the contents viewer 620 has been edited using the attribute edit view 630. If it is determined that the attribute specification has not been edited at Step 435, the process returns from Step 435 to Step 430 through a NO arrow, and the edit of the contents 332 is continued.

If it is determined that the attribute specification has been edited at Step 435, the process proceeds from Step 435 to Step 440 through a YES arrow. At Step 440, the tree structure search unit 350 searches the tree structure contained in the contents data 332 in order to determine that the determination of the appearance by the attribute specification and the determination of the appearance by the style for the element to be edited may be different.

The process proceeds to Step 445, and as the result that the tree structure was searched at Step 440, it is determined whether or not the determination of the appearance by the attribute specification and the determination of the appearance by the style for the element to be edited may be different. If it is determined that there is no difference at Step 445, the process proceeds from Step 445 to Step 475 through a NO arrow and a change of the attribute by the attribute specification is actually carried out. The process then proceeds to Step 480.

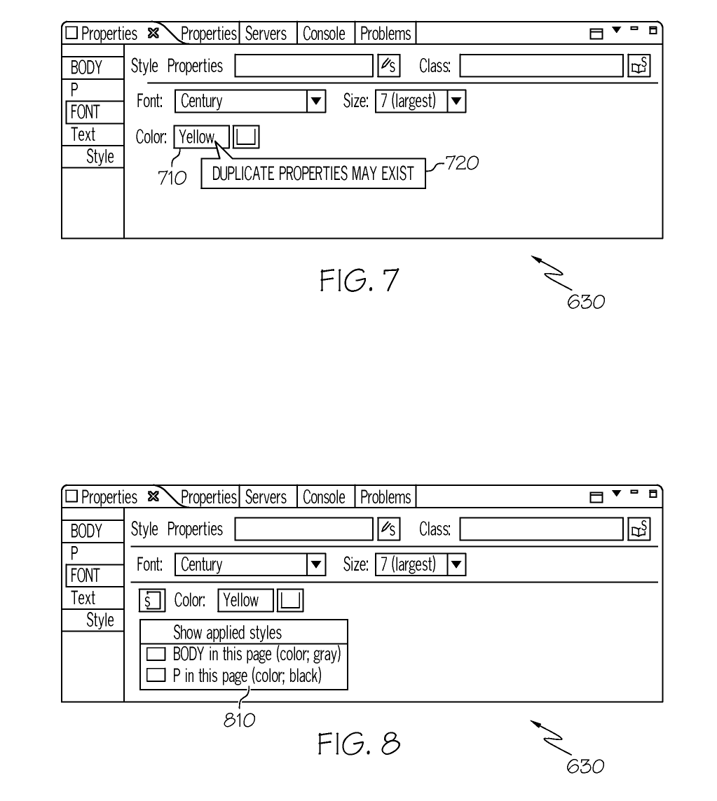

If it is determined that there is a difference at Step 445, the process proceeds from Step 445 to Step 450 via the YES arrow and a warning message 720 that there is a difference is displayed in the attribute edit view 630 for the contents creator. FIG. 7 illustrates the attribute edit view 630 with displaying of the warning message 720 that a difference has arisen between a “color” attribute 710 of the attribute specification and the style.

The process proceeds to Step 455 and it is displayed which style differs from the attribute specification to be edited in the attribute edit view 630, to the contents creator. FIG. 8 illustrates the attribute edit view 630 with displaying of the interface 810 displaying the information on the differing style. The interface 810 also provides a function to edit the style differing from the attribute specification. The process proceeds to Step 460 in which the edit of the style is received from the contents creator, using such a function of the interface 810.

The process further proceeds to Step 465 and it is determined whether or not the style has been edited by having received the edit of the style from the interface 810 of the attribute edit view 630 at Step 460. If it is determined that the style has not been edited at Step 465, the process directly proceeds from Step 465 to Step 475 through the NO arrow and the change of the attribute is actually carried out. The process then proceeds to Step 480.

If it is determined that the style has been edited at Step 465, the process proceeds from Step 465 to Step 470 through the YES arrow and the change of the style is actually carried out. The process then proceeds to Step 475 and, after the change of the attribute was actually carried out, the process proceeds to Step 480.

At Step 480, it is determined whether or not reception of the user input and the edit have been thoroughly completed as to whether or not the edit of the contents has all been completed. If it is determined that the edit has not been completed from the user input, the process returns from Step 480 to Step 430 through the NO arrow and the edit of the contents 332 is continued. If it is determined that the edit has been completed from the information inputted by the user, the process proceeds to Step 485 to be ended.

Next, search process of the tree structure at Step 440 of FIG. 4 will be described in more detail using a flow chart 500 of FIG. 5. Suppose that in the embodiment of the present invention, the contents creator tries to change the attribute from the attribute edit view 630 regarding a “color” attribute of the character string “Result” in the “FONT” element of the contents 332 illustrated in FIG. 9 at Step 430. In this case, the style related to the “color” attribute is searched by performing the process of the flow chart 500.

The process starts at Step 505, and at Step 510, the element name of the element to which the attribute to be changed from the attribute edit view 630 at Step 430 belongs is specified. In the embodiment of the present invention, the “FONT” element to which the “color” attribute to be changed belongs is specified at Step 5 10.

Next, the process proceeds to Step 515 and the whole of the information related to the style applied to the element whose element name has been specified at Step 510 is acquired. As a result, the information that the style by the descriptions of 920 and 960 is applied in a “FONT” element is acquired.

The process proceeds to Step 520 and one or more styles acquired at Step 515 are rearranged in the order of priority. As described above, the style specification by the style attribute (940) is given the highest priority to in the same element, and then the style specification by the ID attribute (930), the style specification by the class attribute (920), and the style specification by the element name (915) are prioritized in that order. A specification given the lowest priority is the attribute specification (970). Moreover, among the elements in the different hierarchies, the style defined within the element with the hierarchical relationship close to the element as an object for determining the appearance thereof is dealt with the high priority. This is the end of the process for the “FONT” element.

Next, in order to determine whether or not there is any element for which the processes at Step 515 and Step 520 should be further performed, it is determined whether or not the element (“FONT” element) having been processed immediately before at Step 520 may be a root element in the tree structure of the contents.

If it is determined that the element is not the root element at Step 525, the process proceeds from Step 525 to Step 530 through the NO arrow, the element name of the parent element (“P” element) is specified, and Steps 515 and 520 are performed for the acquired parent element.

If it is determined that the element is the root element at Step 525, the process proceeds to Step 535 through the YES arrow. Namely, it should be noted that Steps 515, 520, 525, and 530 are repeated until the process for the root element (“HTML” element) is completed, and that there is acquired information on which (1) the style by the descriptions of 920 and 960 is applied to the “FONT” element, (2) the style by the descriptions of 930 and 950 is applied to the “P” element, and (3) the style by the description of 940 and the style by the description of 915 are applied to the “BODY” element.

At Step 535, based on the correspondence table 348 (as an example, the correspondence table of the “FONT” element in the embodiment of the present invention is illustrated in FIG. 11), a style name of the style (in the “FONT” element, “color” serves as the style name) corresponding to the attribute specification (the “color” attribute) intended to be changed from the attribute edit view 630 at Step 430 is specified.

The process proceeds to Step 540 in which only the styles related to the style names specified at Step 535 are extracted from all the styles acquired by repeating Steps 515 through 530. In this way, the style related to the attribute specification (the “color” attribute) intended to be changed from the attribute edit view 630 is searched, and the process proceeds to Step 545 to be ended.

As described above, according to the embodiment of the present invention, it is achieved to provide the authoring system, the software, and the method for efficiently supporting the edit or creation of the contents as a structured document. Hence, it can be readily understood that it is possible to remarkably increase productivity of the user creating the contents with the contents authoring system.

The present invention is achievable as hardware, software, or a combination of hardware and software. In execution by the combination of the hardware and software, the execution in the data processing system having a predetermined program is cited as a typical example. In this case, by the predetermined program being loaded onto the data processing system and being executed, the program controls the data processing system and performs the processing according to the present invention. This program contains a group of instructions which can be expressed by arbitrary language, code, and notations. Such a group of instructions enables the system to execute a certain function directly or after (1) conversion to a different language, code, or notation, and/or (2) duplication to a different medium have/has been carried out.

The present invention apparently includes not only such a program itself but also the medium having recorded the program within the scope thereof. The program for performing the function of the present invention can be stored in an arbitrary computer readable recording medium, such as the flexible disk, the MO, the CD-ROM, a DVD, the hard disk drive unit, a ROM, an MRAM, or a RAM. The program can be downloaded from other data processing systems connected via a communication line or duplicated from other recording media for storing in the recording medium. The program can also be compressed or divided into a plurality of pieces to be stored in a single medium or multiple recording media. In addition, it should be noted that it is surely possible to provide the program product for carrying out the present invention in various forms as well.

It is obvious to a person skilled in the art that various modifications or improvements can be added to the embodiments described above. For example, in the embodiment of the present invention, a warning message that there is a style overlapping with the attribute specification and an interface for displaying and editing the style overlapping with the attribute specification are displayed on condition that it is determined that the determination by the attribute specification and the determination by the style overlap each other and differ therebetween, as for the appearance of the element to be edited. However, it is also possible to display such a warning message and an interface on condition that it is only determined that there is an overlapping style regardless of whether determination by the attribute specification and the determination by the style differ at the time of having selected a certain attribute specification on the attribute edit view. Naturally, the mode to which such a modification or improvement is added is also included in the technical scope of the present invention.

What is claimed is:

1. An authoring system for creating contents, the authoring system comprising:
a storage unit for storing the contents including one or more elements, a tree structure of the elements, a first attribute value for determining appearance of a first element by performing specification for the first element as an object for determining the appearance thereof, and a second attribute value for determining the appearance of the first element by applying specification for either whole contents or the one or more elements to the first element;
a first display unit for displaying a first graphical user interface for performing specification for the first attribute value;
a search unit for searching the tree structure contained in the contents to determine whether or not determination by the first attribute value and determination by the second attribute value may overlap each other with regard to the appearance of the first element to be edited, using the first graphical user interface; and
a second display unit for displaying information related to an overlapping on the first graphical user interface, on condition that the search unit has determined that the determination by the first attribute value and the determination by the second attribute value overlap.

2. The authoring system according to claim 1, wherein the first display unit displays a second graphical user interface for achieving specification for the second attribute value.

3. The authoring system according to claim 1, wherein the first display unit displays a viewer for displaying the contents to be edited.

4. The authoring system according to claim 3, wherein the first display unit updates the display of the contents on the viewer to a newest state in response to the contents to have been edited.

5. The authoring system according to claim 3, wherein the first display unit displays the appearance by the second attribute value as a priority on condition that the determination by the first attribute value and the determination by the second attribute value overlap each other with regard to the appearance of the first element.

6. The authoring system according to claim 1, further comprising a first editing unit for reflecting edit of the first attribute value inputted through the first graphical user interface in the contents stored in the storage unit.

7. The authoring system according to claim 1, further comprising a second editing unit for reflecting edit of the second attribute value inputted through the second graphical user interface in the contents stored in the storage unit.

8. The authoring system according to claim 1, wherein the contents are web contents created in accordance with an HTML language specification.

9. The authoring system according to claim 6, wherein the first attribute value is attribute specification in HTML language and the second attribute value is a style in the HTML language.

10. The authoring system according to claim 1, wherein the contents are web contents created in accordance with an XML language specification.

11. The authoring system according to claim 1, wherein the second attribute value is stored in a file other than a data file of the contents.

12. The authoring system according to claim 1, wherein the search unit includes an algorithm for determining that the determination by the first attribute value and the determination by the second attribute value overlap each other.

13. The authoring system according to claim 1, further comprising a correspondence table of the first attribute value and the second attribute value, wherein the search unit performs search of the tree structure, using the correspondence table.

14. The authoring system according to claim 11, wherein the correspondence table is formed in an XML format.

15. The authoring system according to claim 1, wherein the second display unit displays a message that there is overlapping on the first graphical user interface on condition that the search unit has determined that there is overlapping.

16. The authoring system according to claim 1, wherein the second display unit displays information for specifying the second attribute value taking precedence over the appearance by the first attribute value on the first graphical user interface on condition that the search unit has determined that there is overlapping.

17. The authoring system according to claim 1, wherein the second display unit provides an interface for editing the second attribute value overlapping with the first attribute value on the first graphical user interface on condition that the search unit has determined that there is overlapping.

18. Authoring software for creating contents, the authoring software causing a computer system to perform the steps of:
storing the contents including one or more elements, a tree structure of the elements, a first attribute value for determining appearance of a first element by performing specification for the first element as an object for determining the appearance thereof, and a second attribute value for determining the appearance of the first element by applying specification for either whole contents or the one or more elements to the first element;
displaying a first graphical user interface for performing specification for the first attribute value;
searching the tree structure contained in the contents to determine whether or not determination by the first attribute value and determination by the second attribute value may overlap each other with regard to the appearance of the first element to be edited, using the first graphical user interface; and
displaying information related to an overlapping on the first graphical user interface, on condition that it has been determined that there is overlapping in the step of searching.

19. An authoring method for creating contents, the method comprising steps of:
storing the contents including one or more elements, a tree structure of the elements, a first attribute value for determining appearance of a first element by performing specification for the first element as an object for determining the appearance thereof, and a second attribute value for determining the appearance of the first element by applying specification for either whole contents or the one or more elements to the first element;
displaying a first graphical user interface for performing specification for the first attribute value;
searching the tree structure contained in the contents to determine whether or not determination by the first attribute value and the determination by the second attribute value may overlap each other for the appearance of the first element to be edited, using the first graphical user interface; and
displaying information related to an overlapping on the first graphical user interface, on condition that it has been determined that there is overlapping in the step of searching.
